(19) United States
(12) Patent Application Publication
(10) Pub. No.: US 2023/0394340 A1
(43) Pub. Date: Dec. 7, 2023

(54) Novel Tropical Geometry-Based Interpretable Machine Learning Method

(71) Applicant: REGENTS OF THE UNIVERSITY OF MICHIGAN, Ann Arbor, MI (US)

(72) Inventors: Kayvan Najarian, Northville, MI (US); Justin Zhang, Troy, MI (US); Keith D. Aaronson, Ann Arbor, MI (US); Jessica R. Golbus, Ann Arbor, MI (US); Jonathan Gryak, West Haven, CT (US); Harm Derksen, Boston, MA (US); Heming Yao, Foster City, CA (US)

(21) Appl. No.: 18/203,146

(22) Filed: May 30, 2023

Related U.S. Application Data
(60) Provisional application No. 63/348,097, filed on Jun. 2, 2022.

(51) Int. Cl. G06N 7/02

(52) U.S. Cl. CPC G06N 7/023

(57) ABSTRACT

A method for denoising magnetic resonance images and data is disclosed herein. An example method includes receiving a series of MRF images from a scanning device; identifying one or more subsets of voxels for the series of MRF images; generating one or more sets of eigenvectors, each set of the one or more sets of eigenvectors corresponding to one of the one or more subsets of voxels, and each eigenvector of the one or more sets of eigenvectors having a corresponding eigenvalue; applying a noise distribution model to each of the eigenvalues; identifying a subset of the eigenvalues as corresponding to noise based on the noise distribution model; and reconstructing the series of MRF images without the subset of eigenvalues identified as corresponding to noise.

### GOVERNMENT LICENSE RIGHTS

This invention was made with government support under federal grant number 2014003 awarded by the National Science Foundation (NSF). The government has certain rights in the invention.

### FIELD OF THE DISCLOSURE

The present disclosure generally relates to fuzzy machine learning models and, more particularly, to generating and training a fuzzy machine learning model and/or a ruleset for a fuzzy machine learning model.

### BACKGROUND

Machine learning (ML) and artificial intelligence (AI) models are used by professionals in a wide variety of fields to analyze large quantities of data and make determinations based on said data. To properly analyze the data and/or make determinations, the ML and AI models often rely on rules programmed into the models in question. However, high performance models that are capable of analyzing complicated problems are often difficult for a user to understand. Notably, such “black box” models lack transparency and justification of the output recommendations and/or analysis, especially for the average individual user, who is often not trained in ML and/or AI programming.

Moreover, present ML and AI models require precise annotated data for training and cannot properly analyze or use the same approximate or “fuzzy” rules that human experts do. Many ML and AI models, for example, cannot properly determine that a parameter is “a little high” the same way a human expert would. As such, an interpretable model for machine learning and/or artificial intelligence with a mechanism to leverage approximate knowledge for formation or training of the model and/or rulesets is desired.

### SUMMARY

In one embodiment, a method for generating and training a fuzzy machine learning model may be provided. The method may be implemented via one or more local or remote processors, servers, sensors, transceivers, memory units, and/or other electronic or electrical components. The method may include: (1) receiving, by one or more processors, a set of input data for the fuzzy machine learning model; (2) encoding, by the one or more processors, the set of input data into fuzzy concepts, wherein the fuzzy concepts are representative of approximate logical relationships between variables; (3) determining, by one or more processors and based on the fuzzy concepts, a ruleset for the fuzzy machine learning model, wherein rules of the ruleset are based on a piecewise categorizing function; and (4) training, by the one or more processors, the ruleset for the fuzzy machine learning model based on the set of input data by: (i) approximating, using tropical geometry, a continuous representation of the piecewise categorizing function, and (ii) generating, based on at least the continuous representation of the piecewise categorizing function, a trained fuzzy ruleset.

In a variation of this embodiment, generating the trained fuzzy ruleset includes: determining, based on at least the continuous representation of the piecewise categorizing function, a distance matrix, wherein the distance matrix is representative of similarity between one or more rules of the ruleset; determining, based on the distance matrix, clusters of rules for the one or more rules of the ruleset; and generating the trained fuzzy ruleset by determining representative rules from each cluster of the clusters of rules.

In another variation of this embodiment, the clusters of rules are determined using a bottom-up hierarchical clustering technique.

In yet another variation of this embodiment, the representative rules are determined based on contribution to an output classification.

In still yet another variation of this embodiment, the set of input data for the fuzzy machine learning model includes at least one rule, and wherein the ruleset for the fuzzy machine learning model includes the at least one rule.

In a variation of this embodiment, generating the trained fuzzy ruleset includes: determining, based on at least the continuous representation of the piecewise categorizing function, the at least one rule can be improved; and training the at least one rule.

In another variation of this embodiment, training the ruleset is agnostic to an accuracy of the at least one rule.

In yet another variation of this embodiment, determining, responsive to training the ruleset, a firing strength for each parameter of at least one rule of the trained fuzzy ruleset; and determining, responsive to training the ruleset, a firing strength for each rule of the trained fuzzy ruleset.

In still yet another variation of this embodiment, the input data includes ordinal variable data and/or continuous variable data, and further wherein the firing strength of a parameter xᵢ of a kth rule is \tilde{x}_{i,k}=A_{i,1,k}l(xᵢ)+A_{i,2,k}m(xᵢ)+ . . . +A_{i,n,k}h(xᵢ), where l(xᵢ) is a first subset of the piecewise categorizing function, m(xᵢ) is a second subset of the piecewise categorizing function, h(xᵢ) is an nth subset of the piecewise categorizing function, A_{i,1,k} are a first and kth entry of an attention submatrix Aᵢ, A_{i,2,k} are a second and kth entry of the attention submatrix Aᵢ, and A_{i,n,k} are an nth and kth entry of the attention submatrix Aᵢ.

In a variation of this embodiment, the input data includes categorical variable data, and further wherein the firing strength of a parameter xⱼ of a kth rule is \tilde{x}_{j,k}=Σ_{d=1}^{L}^{ⱼ} A_{j,d,k}l_{d}(xⱼ), where l_{d}(xⱼ) is a first subset of the piecewise categorizing function and A_{j,d,k} are a dth and kth entry of an attention submatrix Aⱼ of dimension Lⱼ×K.

In another variation of this embodiment, the firing strength of a kth rule is

$${r}_{k} = {( {\sum }_{i = 1}^{H} \tilde{x} {}_{i , k}^{{M}_{i , k} \cdot ( \frac{{ϵ}_{{2}_{}} - 1}{{ϵ}_{2}} )} - H + 1 )}^{\frac{{ϵ}_{{2}_{}}}{{ϵ}_{2} - 1}} ,$$

where \tilde{x}_{i,k} is the firing strength of a parameter xᵢ for the kth rule, 0<∈₂<1, and M_{i,k} is an entry in a connection matrix M of dimension H×K that denotes a contribution of xᵢ to the kth rule.

In yet another variation of this embodiment, the method further comprises: determining, responsive to determining the firing strength of each parameter and the firing strength of each rule, the contribution of each rule to one or more outcome classes.

In still yet another variation of this embodiment, the method further comprises outputting the trained fuzzy ruleset.

In a variation of this embodiment, outputting the trained fuzzy ruleset includes outputting an indication of a contribution of each rule to one or more outcome classes.

In another variation of this embodiment, generating the trained fuzzy ruleset includes: iteratively training one or more parameters of the ruleset to find a local minimum output and/or a local maximum output of the ruleset using a gradient descent algorithm; and generating the trained fuzzy ruleset based on the local minimum output and/or the local maximum output of the ruleset.

In yet another variation of this embodiment, the piecewise categorizing function defines whether a received variable follows a high membership function, a medium membership function, or a low membership function.

In still yet another variation of this embodiment, the piecewise categorizing function is defined as

$${f}_{{ϵ}_{1}} ( x ) = {ϵ}_{1} log ( 1 + exp ( \frac{x}{{ϵ}_{1}} ) ) ,$$

the low membership function is

$$l ( x ) = {f}_{{ϵ}_{1}} ( \frac{{a}_{i , 2} - x}{{a}_{i , 2} - {a}_{i , 1}} ) - {f}_{{ϵ}_{1}} ( \frac{{a}_{i , 1} - x}{{a}_{i , 2} - {a}_{i , 1}} ) ,$$

the high membership function is

$$h ( x ) = {f}_{{ϵ}_{1}} ( \frac{x - {a}_{i , w}}{{a}_{i , w + 1} - {a}_{i , w}} ) - {f}_{{ϵ}_{1}} ( \frac{x - {a}_{i , w + 1}}{{a}_{i , w + 1} - {a}_{i , w}} ) ,$$

and the medium membership function is

$$m ( x ) = {f}_{{ϵ}_{1}} ( \frac{x - {a}_{i , 1}}{{a}_{i , 2} - {a}_{i , 1}} ) - {f}_{{ϵ}_{1}} ( \frac{x - {a}_{i , 2}}{{a}_{i , 2} - {a}_{i , 1}} ) - {f}_{{ϵ}_{1}} ( \frac{{a}_{i , w} - x}{{a}_{i , w + 1} - {a}_{i , w}} ) + {f}_{{ϵ}_{1}} ( \frac{{a}_{i , w + 1} - x}{{a}_{i , w + 1} - {a}_{i , 2}} ) - 1 ,$$

where tunable hyperparameters α_{i,1}<α_{i,2}< . . . <α_{i,w}<α_{i,w+1}, and 0<∈₁<1.

In a variation of this embodiment, the fuzzy machine learning model is configured to receive input data as each of ordinal variable data, continuous variable data, or categorical variable data.

In another variation of this embodiment, the trained fuzzy ruleset is a set of rules for one of: (i) making a medical diagnosis; (ii) making a financial determination; or (iii) detecting intrusion into a secure network.

In another embodiment, a system for generating and training a fuzzy machine learning model may be provided. The system may include: (I) one or more processors; (II) a memory; and (III) a non-transitory computer-readable medium coupled to the one or more processors and the memory and storing instructions thereon that, when executed by the one or more processors, cause the computing device to: (1) receive a set of input data for the fuzzy machine learning model; (2) encode the set of input data into fuzzy concepts, wherein the fuzzy concepts are representative of approximate logical relationships between variables; (3) determine, based on the fuzzy concepts, a ruleset for the fuzzy machine learning model, wherein rules of the ruleset are based on a piecewise categorizing function; and (4) train the ruleset for the fuzzy machine learning model based on the set of input data by: (i) approximating, using tropical geometry, a continuous representation of the piecewise categorizing function, and (ii) generating, based on at least the continuous representation of the piecewise categorizing function, a trained fuzzy ruleset.

In a variation of this embodiment, generating the trained fuzzy ruleset includes: determining, based on at least the continuous representation of the piecewise categorizing function, a distance matrix, wherein the distance matrix is representative of similarity between one or more rules of the ruleset, determining, based on the distance matrix, clusters of rules for the one or more rules of the ruleset, and generating the trained fuzzy ruleset by determining representative rules from each cluster of the clusters of rules.

In another variation of this embodiment, the clusters of rules are determined using a bottom-up hierarchical clustering technique.

In yet another variation of this embodiment, the representative rules are determined based on contribution to an output classification.

In still yet another variation of this embodiment, the set of input data for the fuzzy machine learning model includes at least one rule, and wherein the ruleset for the fuzzy machine learning model includes the at least one rule.

In a variation of this embodiment, generating the trained fuzzy ruleset includes: determining, based on at least the continuous representation of the piecewise categorizing function, the at least one rule can be improved; and training the at least one rule.

In another variation of this embodiment, training the ruleset is agnostic to an accuracy of the at least one rule.

In yet another variation of this embodiment, the non-transitory computer-readable medium further stores instructions that, when executed by the one or more processors, cause the computing device to further: determine, responsive to training the ruleset, a firing strength for each parameter of at least one rule of the trained fuzzy ruleset; and determine, responsive to training the ruleset, a firing strength for each rule of the trained fuzzy ruleset.

In still yet another variation of this embodiment, the input data includes ordinal variable data and/or continuous variable data, and further wherein the firing strength of a parameter xᵢ of a kth rule is \tilde{x}_{i,k}=A_{i,1,k}l(xᵢ)+A_{i,2,k}m(xᵢ)+ . . . +A_{i,n,k}h(xᵢ), where l(xᵢ) is a first subset of the piecewise categorizing function, m(xᵢ) is a second subset of the piecewise categorizing function, h(xᵢ) is an nth subset of the piecewise categorizing function, A_{i,1,k} are a first and kth entry of an attention submatrix Aᵢ, A_{i,2,k} are a second and kth entry of the attention submatrix Aᵢ, and A_{i,n,k} are an nth and kth entry of the attention submatrix Aᵢ.

In a variation of this embodiment, the input data includes categorical variable data, and further wherein the firing strength of a parameter xⱼ of a kth rule is \tilde{x}_{j,k}=Σ_{d=1}^{L}^{ⱼ}A_{j,d,k}l_{d}(xⱼ), where l_{d}(xⱼ) is a first subset of the piecewise categorizing function and A_{i,d,k} are a dth and kth entry of an attention submatrix Aⱼ of dimension Lⱼ×K.

In another variation of this embodiment, the firing strength of a kth rule is

$${r}_{k} = {( {\sum }_{i = 1}^{H} \tilde{x} {}_{i , k}^{{M}_{i , k} \cdot ( \frac{{ϵ}_{{2}_{}} - 1}{{ϵ}_{2}} )} - H + 1 )}^{\frac{{ϵ}_{{2}_{}}}{{ϵ}_{2} - 1}} ,$$

where \tilde{x}_{i,k} is the firing strength of a parameter xᵢ for the kth rule, 0<∈₂<1, and M_{i,k} is an entry in a connection matrix M of dimension H×K that denotes a contribution of xᵢ to the kth rule.

In yet another variation of this embodiment, the non-transitory computer-readable medium further stores instructions that, when executed by the one or more processors, cause the computing device to further: determine, responsive to determining the firing strength of each parameter and the firing strength of each rule, the contribution of each rule to one or more outcome classes.

In still yet another variation of this embodiment, the non-transitory computer-readable medium further stores instructions that, when executed by the one or more processors, cause the computing device to further: output the trained fuzzy ruleset.

In a variation of this embodiment, outputting the trained fuzzy ruleset includes outputting an indication of a contribution of each rule to one or more outcome classes.

In another variation of this embodiment, generating the trained fuzzy ruleset includes: iteratively training one or more parameters of the ruleset to find a local minimum output and/or a local maximum output of the ruleset using a gradient descent algorithm; and generating the trained fuzzy ruleset based on the local minimum output and/or the local maximum output of the ruleset.

In yet another variation of this embodiment, the piecewise categorizing function defines whether a received variable follows a high membership function, a medium membership function, or a low membership function.

In still yet another variation of this embodiment, the piecewise categorizing function is defined as

$${f}_{{ϵ}_{1}} ( x ) = {ϵ}_{1} log ( 1 + exp ( \frac{x}{{ϵ}_{1}} ) ) ,$$

the low membership function is

$$l ( x ) = {f}_{{ϵ}_{1}} ( \frac{{a}_{i , 2} - x}{{a}_{i , 2} - {a}_{i , 1}} ) - {f}_{{ϵ}_{1}} ( \frac{{a}_{i , 1} - x}{{a}_{i , 2} - {a}_{i , 1}} ) ,$$

the high membership function is

$$h ( x ) = {f}_{{ϵ}_{1}} ( \frac{x - {a}_{i , w}}{{a}_{i , w + 1} - {a}_{i , w}} ) - {f}_{{ϵ}_{1}} ( \frac{x - {a}_{i , w + 1}}{{a}_{i , w + 1} - {a}_{i , w}} ) ,$$

and the medium membership function is

$$m ( x ) = {f}_{{ϵ}_{1}} ( \frac{x - {a}_{i , 1}}{{a}_{i , 2} - {a}_{i , 1}} ) - {f}_{{ϵ}_{1}} ( \frac{x - {a}_{i , 2}}{{a}_{i , 2} - {a}_{i , 1}} ) - {f}_{{ϵ}_{1}} ( \frac{{a}_{i , w} - x}{{a}_{i , w + 1} - {a}_{i , w}} ) + {f}_{{ϵ}_{1}} ( \frac{{a}_{i , w + 1} - x}{{a}_{i , w + 1} - {a}_{i , 2}} ) - 1 ,$$

where tunable hyperparameters α_{i,1}<α_{i,2}< . . . <α_{i,w}<α_{i,w+1}, and 0<∈₁<1.

In a variation of this embodiment, the fuzzy machine learning model is configured to receive input data as each of ordinal variable data, continuous variable data, or categorical variable data.

In another variation of this embodiment, the trained fuzzy ruleset is a set of rules for one of: (i) making a medical diagnosis; (ii) making a financial determination; or (iii) detecting intrusion into a secure network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a diagram depicting an example system for training and/or applying a model using a tropical geometry-based interpretable machine learning method;

FIG. 2A illustrates a diagram depicting methods for receiving an input dataset and extracting rules therefrom as well as for receiving a trained model and dataset and subsequently developing a summarized ruleset, to be implemented in the system of FIG. 1;

FIG. 2B illustrates a diagram depicting further systems and methods for receiving an input dataset and extracting rules therefrom, to be implemented in the system of FIG. 1;

FIGS. 3-4 illustrate example visualizations of rulesets and concepts, as well as contributions of the rulesets to positive classes;

FIG. 5 illustrates an example flowchart depicting a method for receiving an input dataset and extracting rules therefrom, to be implemented in the system of FIG. 1; and

### DETAILED DESCRIPTION

When evaluating or describing concepts and/or characteristics, human actors use fuzzy descriptions without a strict definition. Such practices are true even for experts making difficult and/or complicated evaluations. For example, a doctor evaluating a patient heart rate may note that the heart rate is “a little high” without explicitly defining the boundaries of what heart rate range constitutes “a little high”. Another expert or, depending on the situation, a layperson may roughly understand the evaluation despite the lack of hard numbers. Similarly, a stockbroker may describe a particular stock as “low performing” or a network analyst may describe security as “light”, and another evaluator would have a rough idea as to what the expert means despite the lack of precision.

However, computers using standard analysis techniques cannot understand the intuitive fuzzy concepts that human experts may understand naturally, leading to disconnects between the computers and the human experts using the computers. Implementing fuzzy concepts into computer-understandable techniques leads to algorithms and functions that are slow or inaccurate. In particular, using piecewise functions to directly represent the fuzzy concepts that are more intuitive to humans provides better accuracy. However, such functions cannot be analyzed and/or improved using standard techniques, such as gradient-based techniques, which are only usable for differentiable functions, but guarantee a convergence. For example, Gaussian functions are a common class of differentiable functions utilized in place of such piecewise functions for gradient-based techniques. The use of such Gaussian functions, however, loses accuracy. Similarly, available techniques for sharper, piecewise functions, such as genetic algorithms, also lack in speed and/or accuracy. Combinatorial or exhaustive search techniques, for example, are often implemented for encoding input data for such functions and require long periods of time to approach any sustainable level of accuracy. Similarly, techniques besides gradient techniques may not guarantee convergence, or may take prohibitive quantities of time to do so.

By using tropical geometry, a system may approximate the sharp piecewise functions with smooth continuous approximations. In some implementations, the system may approximate the smooth continuous approximations such that the smooth approximations are infinitely close to the sharp edges while still being continuous. Similarly, the system may take data from any number of sources to clarify how to encode various fuzzy concepts and how to determine which concepts and/or variables are relevant to a final determination.

By using tropical geometry to approximate fuzzy concepts, a system can generate and/or pull rules from a model and train the rules to improve the general accuracy and speed of making determinations. Similarly, because the concepts are fuzzy, the model is transparent and easy for humans to understand, unlike standard techniques, in which the determinations are largely oblique and/or difficult for even experts to understand.

Further, a system using tropical geometry to approximate fuzzy concepts can (i) improve good rules using input data, (ii) create rules from only input data, or (iii) determine that a ruleset is incomplete and/or incorrect. As such, the system is capable of removing irrelevant rules or generating new rules to improve the overall determination made by an expert or individual assessing or evaluating a condition. Similarly, such a system may present combinations of rules and/or variables that would normally be overlooked or missed by traditional systems that rely on receiving rules to train. Moreover, incorporating good rules into a model reduces the amount of training data needed to achieve a given level of accuracy in performance, generally improving the overall system performance.

Moreover, because the techniques described herein are able to determine and remove redundant, unimportant, or incorrect rules and/or data, the system may make determinations as to improved rules and/or variables agnostic to the inputs, whether the input rules are accurate, and/or the type of data the system receives. For example, a model created by the techniques described herein may receive numerical data, binary data, ordinal data, continuous data, categorical data, or any other similar data type as input and use the different types in conjunction.

As such, the system can handle noise that would otherwise destroy any convergence that standard techniques could potentially attain.

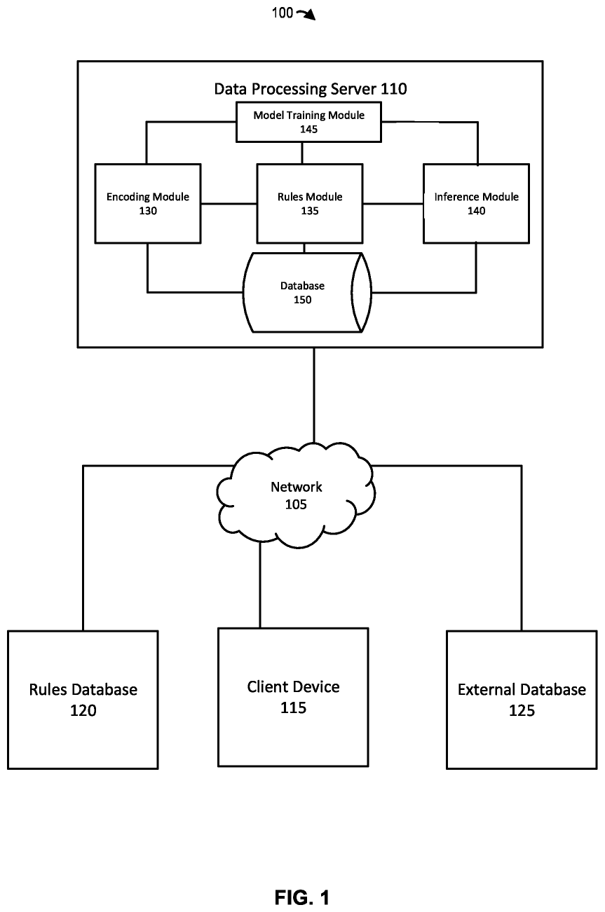

Referring first to FIG. 1, an example system for training and/or applying a model using a tropical geometry-based interpretable machine learning method includes a network 105, a data processing server 110, and at least one of a client device 115, a rules database 120, and/or an experimental database 125. The data processing server may additionally include a data processing database 150 as well as various modules to process data and train a machine learning model, such as encoding module 130, rules module 135, inference module 140, and/or model training module 145.

The data processing server 110 includes at least one processor and a memory. The memory stores computer-executable instructions that, when executed by the processor, cause the processor to perform one or more of the operations described herein. The processors may include a variety of generic and/or specialized processors (or “processing devices”), such as microprocessors, application-specific integrated circuits (ASOIC), digital signal processors, customized processors, field programmable gate arrays (FPGAs), or any combination thereof.

Similarly, the memory may include a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, or any other suitable memory from which the processor can read instructions. The instructions can include code from any suitable programming language. Though not illustrated in FIG. 1, the data processing server 110 can include and/or is communicatively coupled to one or more computing devices or servers that can perform various functions.

The instructions stored in the memory of data processing server 110 may be instructions for implementing the various functionalities described herein for respective systems, as well as any data relating thereto, generated thereby, or received via any communications interface(s) and/or input device(s). In some implementations, the data processing server 110 includes the memory to store data structures and/or information related to, for example, software components of the data processing server 110 and/or algorithms used in training, testing, or utilizing models to create, extract, and/or improve rulesets according to analyzed input data and/or rulesets as described in more detail below. In some such implementations, the memory includes or is part of the data processing database 150. The processor(s) may execute instructions stored in the memory and, in so doing, may also read from and/or write to the memory various information processed and/or generated pursuant to execution of the instructions.

The processor(s) of the data processing server 110 also may be communicatively coupled to and/or control a communications interface of the data processing server 110 to transmit and/or receive various information pursuant to execution of instructions via the network 105. For example, the communications interface(s) may be coupled to a wired or wireless network, bus, and/or other communication means, and may therefore allow the data processing server 110 to transmit information to and/or receive information from other devices (e.g., other computer systems). Moreover, one or more communication interfaces facilitate information flow between the components of the data processing server 110. In some implementations, the communications interface(s) may be configured (e.g., via various hardware and/or software components) to provide a website and/or application to at least some aspects of the data processing server 110 as an access portal.

Further, the data processing server 110 may include output devices that, for example, allow a user to view and/or otherwise perceive various information in connection with the execution of the instructions. Similarly, the data processing server 110 may include input devices that, for example, allow a user to make manual adjustments, make selections, enter data, and/or interact in any of a variety of manners with the processor during execution of the instructions.

In some implementations, the network 105 can be and/or include any wireless or wired networks through which computing devices may communicate. For example, the network 105 may include the Internet, a local area network (LAN), a wide area network (WAN), a metropolitan area network, one or more intranets, an optical network, a cellular network, a satellite network, other types of data network, and/or a combination thereof.

The data processing server 110 is capable of communicating via the network 105 with the one or more client devices 115, rules database 120 and/or the external database 125. The network 105 can include any number of network devices, such as gateways, switches, routers, modems, repeaters, and wireless access points, among others. The network 105 can also include computing devices such as computer servers. The network 105 can also include any number of hardwired and/or wireless connections.

The one or more client devices 115 can include a computing device configured to acquire, display, and transmit data and/or rules to be analyzed by the data processing server 110 as well as receive content (e.g., third-party content items such as texts, software programs, images, and/or videos) provided by the data processing server 110. The client device 115 can transmit and/or request and receive such content via the network 105. The client device 115 can include a desktop computer, laptop computer, tablet device, smartphone, personal digital assistant, mobile device, consumer computing device, server, digital video recorder, set-top box, smart television, or any other computing device capable of communicating via the network 105 and transmitting and/or receiving the data and/or analysis for data processing server 110. While FIG. 1 shows a single client device 115, the system 100 can include a plurality of client devices 115 served by the data processing server 110.

The rules database 120 and/or external database 125 can include servers or other computing devices to provide input data and/or input rules for the data processing server 110. The input data and/or input rules can include raw data, such as electrocardiogram (ECG) signals; processed data, such as survey data; fuzzy rules, such as a rule stating that if ejection fraction (EF) is low, and peak oxygen consumption (pVO2) is low, then evaluate for heart transplant and/or mechanical circulatory support (HT/MCS); or any other similarly desired input data. In further implementations, the rules database 120 and/or external database 125 can receive and store data such as improved and/or new rulesets from the data processing server 110. Although FIG. 1 shows the rules database 120 as separate from the external database 125, the system 100 can include both databases 120 and 125 as a single combined database as well.

The database 150 can maintain a data structure such as a table of input data, corresponding rules, and/or determinations associated with the input data and/or rules. The database can further maintain one or more data structures regarding database or client device identifiers and/or information, such as a tree, a linked list, a table, a string, or a combination thereof.

The data processing server 110 further includes a number of logic modules. In some implementations, the data processing server 110 includes an encoding module 130, a rules module 135, an inference module 140, and/or a model training module 145. Depending on the implementation, each of the encoding module 130, rules module 135, inference module 140, and/or model training module 145 can be implemented as a software module, hardware module, or a combination of both. For example, each module can include a processing unit, server, virtual server, circuit, engine, agent, appliance, or other logic device such as programmable logic arrays configured to communicate with the data processing database 150 and/or with other computing devices via the network 105. The computer-executable instructions stored in the memory of the data processing server 110 can include instructions which, when executed by one or more processors, cause the data processing server 110 to perform operations discussed below with regard to any of and/or any combination of the encoding module 130, rules module 135, inference module 140, and/or model training module 145.

The encoding module 130 receives input data from the system 100. In particular, the encoding module 130 can receive input data from the data processing database 150 and/or from any of the client device 115, the rules database 120, or the experimental database 125 via the network 105. The input data may be ordinal data, continuous data, categorical data, etc.

Depending on the implementation, the input data can be raw data, such as ECG signals; processed data, such as survey data; fuzzy rules, such as a rule stating that if EF is low, and pVO2 is low, then then evaluate for HT/MCS; or any other similarly desired input data.

In some implementations, the encoding module 130 then uses fuzzy theory to encode variables into multiple fuzzy sets. The encoding module 130 assigns a membership value in the range of [0,1] to each variable based on the observed value for a given fuzzy set, indicating the confidence of the variable belonging to a given concept and/or set (i.e., with 0 referring to no confidence and 1 referring to complete confidence). In some implementations, the encoding module 130 uses membership functions to calculate the membership values. In further implementations, the model training module 145 trains the membership functions while training the machine learning model as a whole.

The encoding module 130 determines concepts for the input variables. In particular, the encoding module 130 encodes the variables into humanly understandable fuzzy concepts. The fuzzy concepts approximate the concepts used by human experts during decision-making. For example, an expert may describe a metric used in making a determination as “low”, “medium”, or “high” without having a firm definition of what constitutes each concept. As examples, a clinician may describe a heart rate as low, medium, or high; a stockbroker may describe a stock as being low, medium, or high; and a network security analyst may describe a level of activity in a network as low, medium, or high. Each expert may make the determination without having a firm bound on what constitutes each category, and may even have crossover between categories (e.g., a heart rate is “a little high”).

The encoding module 130 then sets trainable membership functions for each of the concepts. For example, in some implementations, the encoding module 130 defines three functions, l(x), m(x), and h(x). In such implementations, the membership functions are defined as

$$l ( x ) = {f}_{{ϵ}_{1}} ( \frac{{a}_{i , 2} - x}{{a}_{i , 2} - {a}_{i , 1}} ) - {f}_{{ϵ}_{1}} ( \frac{{a}_{i , 1} - x}{{a}_{i , 2} - {a}_{i , 1}} ) , \\ h ( x ) = {f}_{{ϵ}_{1}} ( \frac{x - {a}_{i , 3}}{{a}_{i , 4} - {a}_{i , 3}} ) - {f}_{{ϵ}_{1}} ( \frac{x - {a}_{i , 4}}{{a}_{i , 4} - {a}_{i , 3}} ) , and \\ m ( x ) = {f}_{{ϵ}_{1}} ( \frac{x - {a}_{i , 1}}{{a}_{i , 2} - {a}_{i , 2}} ) - {f}_{{ϵ}_{1}} ( \frac{x - {a}_{i , 2}}{{a}_{i , 2} - {a}_{i , 1}} ) - {f}_{{ϵ}_{1}} ( \frac{{a}_{i , 3} - x}{{a}_{i , 4} - {a}_{i , 3}} ) + {f}_{{ϵ}_{1}} ( \frac{{a}_{i , 4} - x}{{a}_{i , 4} - {a}_{i , 3}} ) - 1 , \\ where {f}_{{ϵ}_{1}} ( x ) = {ϵ}_{1} log ( 1 + exp ( \frac{x}{{ϵ}_{1}} ) ) ,$$

tunable hyperparameters α_{i,1}<α_{i,2}<α_{i,3}<α_{i,4}, and 0<∈₁<1. In such implementations, α_{i,1}<α_{i,2}<α_{i,3}<α_{i,4} are trainable variables in the form of tunable hyperparameters. Depending on the implementation, the number of tunable hyperparameters varies dependent upon the number of categories considered. Although four tunable hyperparameters are described above, it will be understood that any number of hyperparameters may be used. For example, the tunable hyperparameters may include α_{i,1}<α_{i,2}< . . . <α_{i,w}<α_{i,w+1}. Similarly, the encoding module may calculate the membership functions according to the above using the tunable hyperparameters. Further, the membership functions have a smoothness modulated by ∈₁. Because

$${lim}_{{ϵ}_{1} \to 0} {f}_{{ϵ}_{1}} ( x ) = max ( 0 , x ) ,$$

when ∈₁ approaches 0, the membership functions approach trapezoidal or triangular membership functions.

As described above, the encoding module 130 then encodes the input variables xᵢ as membership values in the fuzzy concepts. It will be understood that though three concepts are described herein, the techniques as described herein may apply to any number of concepts, and three concepts are chosen for ease of illustration and explanation.

In some implementations, the encoding module 130 may determine whether to encode the variables into fuzzy concepts based on the type of data input received. For example, the encoding module 130 may determine to encode the input data variables into fuzzy concepts when the data input is an ordinal or continuous variable, but may instead directly encode categorical variables, such that xⱼ is encoded into l₁(xⱼ), l₂(xⱼ), . . . , l_{Lj}(xⱼ), where Lⱼ is the number of levels of xⱼ and only one of l₁(xⱼ), l₂(xⱼ), . . . , l_{Lj}(xⱼ) has a value of 1, while all others have a value of 0.

The rules module 135 determines the most relevant concept from each variable for each rule and calculates a firing strength (e.g., a weight) for each rule. In some implementations, the architecture of the rules module 135 includes two layers. In such implementations, the first layer of the rules module 135 selects the most relevant concept from each variable for each rule, and the second layer calculates the rule firing strength for each rule. Although the application generally refers to two layers, it will be understood that a rules module 135 may have fewer, more, or alternate layers, depending on the implementation.

In some implementations, the rules module 135 determines the most relevant concept from each variable with respect to each rule using an attention matrix A. A is the partitioned matrix formed by concatenating submatrices A₁, A₂, . . . , A_{H}, where Aₕ is the attention submatrix for the input variable xₕ and H=I+J is the total number of input variables. Further, I and J are the total number of ordinal/continuous variables and categorical variables, respectively. In some implementations, the rules module 135 treats ordinal and continuous variables differently from categorical variables. For example, for an ordinal and/or continuous variable xᵢ, the submatrix Aᵢ with entries A_{i,m,n} has dimension Cₚ×K, where Cₚ is the number of concepts for ordinal or continuous variables, and K is the number of rules utilized in the network. In some implementations, Cₚ=3 and refers to the concepts “high”, “medium”, and “low” as described with regard to the encoding module 130 above. Similarly, for a categorical variable xⱼ, the submatrix Aⱼ with entries A_{j,m,n} has dimension Lⱼ×K, where Lⱼ is the number of levels of xⱼ. As such, the attention matrix A has dimension (Cₚ·I+ΣⱼLⱼ)×K.

In implementations in which Cₚ=3, the entry A_{i,1,k} in the attention matrix may represent the contribution of the ordinal or continuous variable xᵢ being “low” to rule k, the entry A_{i,2,k} in the attention matrix may represent the contribution of xᵢ being “medium” to rule k, and the A_{i,3,k} in the attention matrix may represent the contribution xᵢ being “high” to rule k. Depending on the implementation, the number may vary, and any A_{i,n,k} may correspond with the appropriate concept. In further implementations, entries in the attention matrix are all trainable and constrained to [0,1] by an activation function, such as a hyperbolic tangent activation function. A higher value in A indicates a higher contribution. For an input variable xᵢ, the corresponding output from the rules module 135, or the first layer of the rules module 135 in implementations in which the rules module 135 includes multiple layers, is \tilde{x}ᵢ, a vector of length K. Further, \tilde{x}_{i,k} is the kth element of \tilde{x}ᵢ and represents the firing strength of xᵢ involved in the kth rule. In implementations in which the rules module 135 treats ordinal and continuous variables differently from categorical variables, then \tilde{x}_{i,k}=A_{i,1,k}l(xᵢ)+A_{i,2,k}m(xᵢ)+ . . . +A_{i,n,k}h(xᵢ) for an ordinal or continuous variable xᵢ, and \tilde{x}_{j,k}=Σ_{d=1}^{Lj}A_{j,a,k}l_{d}(xⱼ) for a categorical variable xⱼ.

In some implementations, the rules module 135 calculates rule firing strength by a connection matrix M of dimension H×K. In further implementations, a second layer of the rules module 135 separate from the first layer of the rules module 135 that selects the most relevant concept from each variable with respect to each rule. The rules module 135 constructs the kth rule as a combination of \tilde{x}_{1,k}, . . . , \tilde{x}_{H,k}. An entry M_{i,k} in the connection matrix M denotes the contribution of xᵢ to the kth rule. In some implementations, entries in the connection matrix are all trainable and constrained to [0,1] by an activation function, such as a hyperbolic tangent activation function, and a higher value indicates a higher contribution.

In order to calculate rₖ, the firing strength of the kth rule, the rules module 135 defines a parameterized T-norm, T_{∈}_{₂} (x, y)=g_{∈}_{₂}⁻¹(g_{∈}_{₂}(x)+g_{E}_{₂}(y)) with g_{∈}_{₂}⁻¹ as the inverse of g_{∈}_{₂}. For 0<∈₂<1, g_{∈}_{₂} in the range of [0, ∞) is defined as

$${g}_{{ϵ}_{2}} ( x ) = ( \frac{{ϵ}_{2}}{1 - {ϵ}_{2}} ) ( 1 - {x}^{\frac{{ϵ}_{2} - 1}{{ϵ}_{2}}} )$$

and g_{∈}_{₂}⁻¹ is defined as

$${g}_{{ϵ}_{2}}^{= 1} ( z ) = {( 1 - \frac{1 - {ϵ}_{1}}{{ϵ}_{2}} z )}^{\frac{{ϵ}_{2}}{{ϵ}_{2} - 1}} .$$

### Therefore,

$${T}_{{ϵ}_{2}} ( x , y ) = {( {x}^{\frac{{ϵ}_{2} - 1}{{ϵ}_{2}}} + {y}^{\frac{{ϵ}_{2} - 1}{{ϵ}_{2}}} - 1 )}^{\frac{{ϵ}_{2}}{{ϵ}_{2} - 1}}$$

with the behavior

$${lim}_{{ϵ}_{2} \to 1} {T}_{{ϵ}_{2}} ( x , y ) = xy and {lim}_{{ϵ}_{2} \to 0} ( x , y ) = min ( x , y ) .$$

Put another way, the rules module 135 can modulate the defined T-norm via ∈₂. In some implementations, the rules module 135 calculates the firing strength rₖ by applying the T-norm to multiple inputs. As such,

$${r}_{k} = {T}_{{ϵ}_{2}} ( {\tilde{x}}_{1 , k}^{{M}_{1 , k}} , {\tilde{x}}_{2 , k}^{{M}_{2 , k}} , … , {\tilde{x}}_{H , k}^{{M}_{H , k}} ) = {g}_{{ϵ}_{2}}^{- 1} ( {\sum }_{i = 1}^{H} {g}_{{ϵ}_{2}} ( {\tilde{x}}_{i , k}^{{M}_{i , k}} ) ) = {( {\sum }_{i = 1}^{H} {\tilde{x}}_{i , k}^{{M}_{i , k} \cdot ( \frac{{ϵ}_{2} - 1}{{ϵ}_{2}} )} - H + 1 )}^{\frac{{ϵ}_{2}}{{ϵ}_{2} - 1}} .$$

In some such implementations, the rules module 135 uses the learned entries in the connection matrix M to vary the contribution and/or weight of each input for a given rule within the T-norm calculation. Further, the lower value in M indicates a lower contribution to the rule firing strength. For example, for \tilde{x}_{1,k}^{M}^{_{1,k}}, a lower M_{1,k} (e.g., closer to 0) means \tilde{x}_{1,k}^{M}^{_{1,k}} is closer to 1 and consequently contributes less to rₖ with the defined T-norm.

The inference module 140 classifies the variables based on the rule firing strength that the rules module 135 calculates. In some implementations, the inference module 140 classifies the variables into C classes. In further implementations, the inference module 140 includes C nodes, one for each class, that are fully connected to nodes of the rules module 135. The inference module 140 calculates the firing strength of each node o_{c} using the rule firing strengths rₖ with an inference matrix W of dimension K×C. An entry W_{j,c} denotes the contribution of the kth rule to the cth class. In some implementations, entries in the inference matrix are all trainable and positive. In further implementations, a higher value in the inference matrix indicates a higher contribution.

In some implementations, the inference module 140 defines a parametrized T-conorm to calculate o_{c}. In particular, the inference module 140 defines the parametrized T-conorm on two inputs as

$${Q}_{{ϵ}_{3}} ( x , y ) = {( {x}^{\frac{1}{{ϵ}_{3}}} + {y}^{\frac{1}{{ϵ}_{3}}} )}^{{ϵ}_{3}} ,$$

where 0<∈₃<1. The T-conorm has asymptotic behavior according to the following:

$${lim}_{{ϵ}_{3} \to 1} {Q}_{{ϵ}_{3}} ( x , y ) = x + y and {lim}_{{ϵ}_{3} \to 0} {Q}_{{ϵ}_{3}} ( x , y ) = max ( x , y ) .$$

Accordingly, the inference module 140 can modulate the defined T-conorm between addition and max by modifying ∈₃. In some such implementations, the inference module 140 then calculates o_{c} according to

$${o}_{c} = {Q}_{{ϵ}_{3}} ( {W}_{1 , c} {r}_{1} , {W}_{2 , c} {r}_{2} , … , {W}_{K , c} {r}_{K} ) = {( {\sum }_{k = 1}^{K} {( {W}_{k , c} {r}_{k} )}^{\frac{1}{{ϵ}_{3}}} )}^{{ϵ}_{3}} .$$

In some further such implementations, after the inference module 140 calculates o₁, o₂, . . . , o_{c}, the inference module 140 applies a softmax activation function to generate probabilities p₁, p₂, . . . , p_{c} of being in each class, which are all in [0,1] with Σ_{c=1}^{C}p_{c}=1. Because the softmax activation functions guarantees that Σ_{c=1}^{C} p_{c}=1, the number of valid nodes in the inference module 140 can be set to C−1 to avoid ambiguity in rule representation. For example, when performing binary classification W_{:,0} can be set to 0 so that the model will only learn subspaces related to the positive class.

Using the encoding module 130, the rules module 135, and the inference module 140, the data processing server 110 is able to both extract and inject fuzzy rules. Put another way, the data processing server 110 is able to extract and inject rules in a way that humans can understand. The entries in the attention matrix A and connection matrix M represent the contribution of individual concepts and individual variables to each rule. The entries in the inference matrix W give the contribution of individual rules to each class.

In some implementations, the data processing server 110 constructs a contribution matrix S using the attention and connection matrices A and M. The contribution matrix S expresses the contribution of individual concepts to each rule in the model. The matrix S is of the same dimension as attention matrix A. Put another way, the matrix S is a partition matrix formed by concatenating submatrices S₁, S₂, . . . , S_{H}. In some implementations, the data processing server 110 treats ordinal and continuous variables different from categorical variables. In such implementations, for an ordinal or continuous variable xᵢ, the corresponding submatrix Sᵢ has dimension 3×K. Similarly, for a categorical variable xⱼ, Sⱼ has dimension Lⱼ×K. The data processing module 110 calculates entries S_{i,d,k} of Sᵢ and S_{j,d,k} of Sⱼ as S_{i,d,k}=A_{i,d,k}×M_{i,k}, d ∈{1,2,3} and S_{j,d,k} A_{j,d,k}×M_{j,k}, d ∈{1,2, . . . , Lⱼ}, where k∈{1,2, . . . , K}. The entry S_{i,d,k} is the contribution of the dth concept of xᵢ to the kth rule. S_{:,:,k} encodes the construction of the kth rule, while W_{k,:} captures the relationship between classes and the kth rule. Further, while the data processing server 110 is described as calculating S_{i,d,k} using 3 fuzzy concepts and thereby limiting d ∈{1,2,3}, it will be recognized that the data processing server 110 can use any appropriate number of fuzzy concepts as described in detail above.

As an example of how the data processing server 110 generates, modifies, and/or represents humanly understandable rules, the data processing server 110 receives a dataset with four continuous input variables x₁, x₂, x₃, x₄ and determines a binary response (negative and positive). A, M, and W are trained and the data processing server 110 can calculate S. Further, take entries S_{1,1,1}, S_{2,3,1}, S_{2,2,2}, and S_{3,1,2} of the contribution matrix S as close to 1, with all other entries of S close to 0. In the inference matrix W, W_{1,2} and W_{2,2} are close to 1 while W_{1,1} and W_{2,1} are close to 0. From the given S and W, the data processing network 110 can summarize two rules from the trained network as follows: (1) If x₁ is low and x₂ is high, then the sample is positive; (2) If x₂ is medium and x₃ is low, then the sample is positive. Each rule is represented in ( [symbol] , W_{1,:}) and ( [symbol] , W_{2,:}), respectively. The data processing server 110 can extract the definitions of low, medium, and high concepts from the parameters in the encoding module 130. The extracted rules mimic human logic, and a user can use the extracted rules to justify the network decisions. In some implementations, the rules are not extracted, but instead the trained model is used as a neural network after being trained, as described in more detail below.

The model training module 145 trains the modules and algorithms described above. In some implementations, the model training module 145 trains the various modules and algorithms by back-propagation with an Adam optimizer. In further implementations, the model training module 145 trains the classification model using a calculated regular cross-entropy loss, loss_{ce}. In still further implementations, the model training module 145 adds an l₁ norm-based regularization term lossₗ_{₁} to the loss function to favor rules with a smaller number of concepts, which are more feasible to use in practice. Further, the model training module 145 calculates the correlation among encoded rules as a loss term loss_{corr} to avoid extracting redundant rules. The loss function is defined as: lossₜₒₜₐₗ=loss_{ce}+λ₁lossₗ_{₁}+λ₂loss_{corr}; lossₗ_{₁}=∥vec(A)∥₁+∥vec(M)∥₁; and loss_{corr}=Σᵢ₌₁^{H-1}Σⱼ₌ᵢ₊₁^{H}i+1vec( [symbol] )vec( [symbol] ), where λ₁ and λ₂ control the magnitude of the l₁ norm-based regularization term and correlation based regularization term, respectively. vec(·) denotes the vectorization of a matrix.

In some implementations, the data processing server 110 constrains ∈₁, ∈₂, ∈₃ to be equal for simplicity. For example, the data processing server 110 may initialize each of the three as 0.99 at the beginning of training and gradually reduce each of ∈₁, ∈₂, ∈₃ with the number of training steps. In some implementations, the scheduling of the E values is defined as ∈=max(∈ₘᵢₙ, ∈·γ^{training_steps}), where γ is the decay rate that can be tuned as a hyperparameter. ∈ₘᵢₙ is another hyperparameter, whose optimal value varies with different applications. In some implementations, the data processing server 110 initializes ∈ to ∈=0.99 and reduces E to improve model optimization as discussed in more detail below.

In some implementations, before model training, the model training module 145 randomly initializes training parameters. In further implementations, the model training module 145 may use practical rules from the data processing database 150, the client device 115, the rules database 120, and/or the experimental database 125 to improve and/or initialize the network parameters. Using such rules to initialize the parameters may improve performance, particularly when the size of the training dataset is small. In the example detailed above, take the generated rules as previously known rules within the rules database 120. In such an example, the model training module 145 could then initialize the matrices A, M, and W as: (1) A: A_{1,1,1}, A_{2,3,1}, A_{2,2,2}, A_{3,1,2} having a higher value and other entries in [symbol] and [symbol] having a lower value; (2) M: M_{1,1}, M_{2,1}, M_{2,2}, M_{3,2} having a higher value and other entries in M_{:,1} and M_{:,2} having a lower value; (3) W: W_{1,2}, W_{2,2} having a high value and W_{1,1}, W_{2,1} having a low value; and (4) other entries in A, M, and W being randomly initialized.

In some further implementations, the model training module 145 assesses and/or evaluates the machine learning model after each iteration of training. For example, the model training module 145 may calculate an accuracy, precision, recall, F₁ value (i.e., the harmonic mean of precision and recall), and/or the area under the receiver operating characteristic curve. In some such implementations, the model training module 145 calculates the evaluation metrics as follows:

$$accuracy = \frac{true positive + true negative}{all positives + all negatives} ; \\ precision = \frac{true positives}{true positives + false positives} ; \\ recall = \frac{true positives}{true positives + false negatives} ; and {F}_{1} = 2 ( \frac{recall * precision}{recall + precision} ) .$$

In further implementations, the model training module 145 calculates generalization gaps as the differences between metrics on validation and test sets. In such implementations, a higher generalization gap indicates greater overfitting.

Depending on the implementation, the model training module 145 outputs the trained model, which a user may use as a neural network to analyze input data. In some implementations, the model training module 145 outputs the trained model in addition to or in place of the trained ruleset. In implementations in which the model training module 145 outputs the trained model in place of the trained ruleset, the trained model may still use the trained ruleset to analyze input data and/or perform other functions as described herein.

In some implementations, the system 100 performs the module functions as outlined above using one or more algorithms and/or a neural network. In further implementations, the system 100 performs the module functions as outlined above to train one or more algorithms and/or a neural network. In some such implementations, to train the algorithms and/or neural network, the model training module 145 uses training data to improve the functionality of the modules and/or the models in question. In particular, in some implementations, the model training module 145 trains the algorithms and/or neural network using a supervised machine learning program or algorithm. The neural network may be a convolutional neural network, a deep learning neural network, or a combined learning module or program that learns in two or more features or feature datasets (e.g., determining the coordinates and classification for input data) in a particular area of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the machine learning based algorithms may be included as a library or package executed on a computing platform (e.g., user computing device 102). For example, libraries may include the TENSORFLOW based library, the PYTORCH library, and/or the SCIKIT-LEARN Python library.

Machine learning may involve identifying and recognizing patterns in existing data (such as training a neural network based on labeled classes and training data) in order to facilitate making predictions or identification for subsequent data (such as using the neural network on new input data in order to generate new rulesets, improve old input rulesets, and/or condense rulesets).

Machine learning model(s) implemented on the neural network(s), such as the encoding module 130, rules module 135, and inference module 140 or the models created by the aforementioned modules, described herein for some embodiments, may be created and trained based upon example data (e.g., “training data” and related input data and/or input rules) inputs or data (which may be termed “features” and “labels”) in order to make valid and reliable predictions for new inputs, such as testing level or production level data or inputs. In supervised machine learning, a machine learning program operating as a neural network on a server, computing device, or otherwise processor(s), may be provided with example inputs (e.g., “features”) and their associated, or observed, outputs (e.g., “labels”) in order for the machine learning program or algorithm in the neural network to determine or discover rules, relationships, patterns, or otherwise machine learning “models” that map such inputs (e.g., “features”) to the outputs (e.g., “labels”), for example, by determining and/or assigning weights or other metrics to the model across its various feature categories. Such rules, relationships, or models may then be provided subsequent inputs in order for the neural network, executing on the server, computing device, or processor(s), to predict, based on the discovered rules, relationships, or models, an expected output.

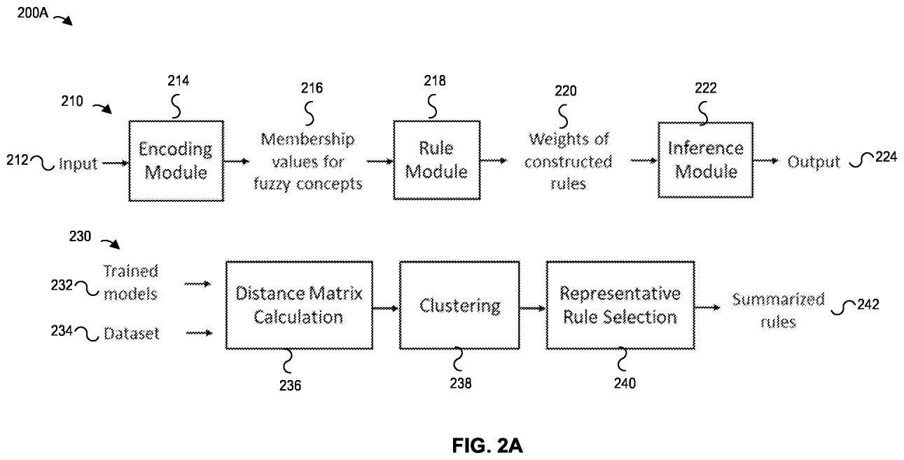

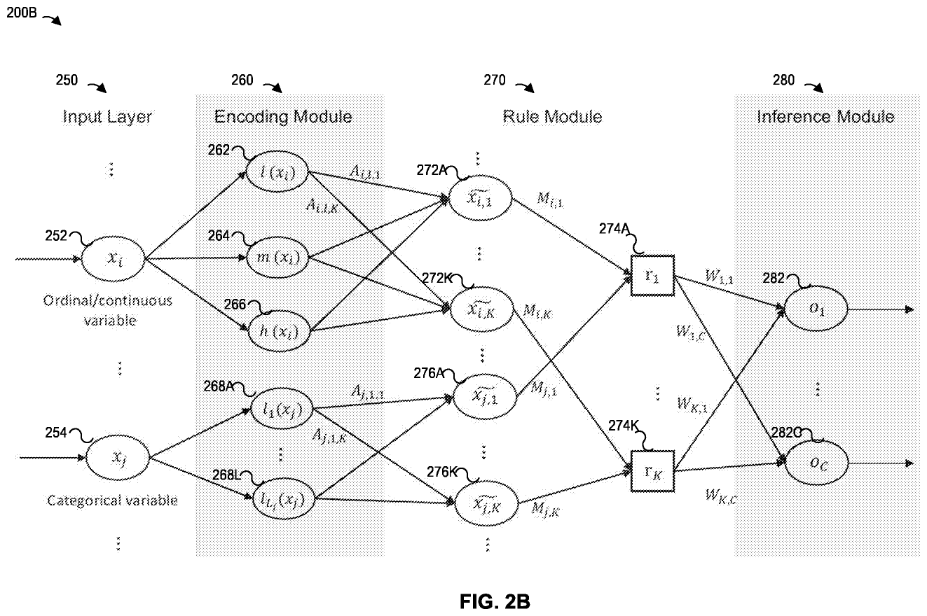

Referring next to FIG. 2A, a diagram 200A illustrates methods for receiving an input dataset and extracting rules therefrom as well as for receiving a trained model and dataset and subsequently developing a summarized ruleset. The method of FIG. 2A may be implemented in a system 100 as described with regard to FIG. 1 above. Though the method below is described with regard to system 100, it will be recognized that any similarly suitable system may be used to implement FIG. 2A.

First, when extracting rules from data and/or training a ruleset using method 210, a data processing server 110 receives input data 212 from any of and/or any combination of a client device 115, a rules database 120, and/or an experimental database 125. In some implementations, the input data comprises ordinal variables, continuous variables, categorical variables, crafted rules, or any other similar data as described herein. Depending on the implementation, the data processing server 110 may receive the input data 212 directly at an encoding module 214, which may be the encoding module 130 as described with regard to FIG. 1 above.

The encoding module 214 then encodes membership values for fuzzy concepts 216. In some implementations, the encoding module 214 assigns a membership value 216 in the range of [0,1] to each variable and/or component of the input data 212 based on the observed value for a given fuzzy set, indicating the confidence of the variable belonging to a given concept and/or set (i.e., with 0 referring to no confidence and 1 referring to complete confidence). In some implementations, the encoding module 214 uses membership functions to calculate the membership values 216. The encoding module 214 then transmits the membership values 216 to the rule module 218. In some implementations, the rule module 218 is the rules module 135 as described with regard to FIG. 1 above.

The rule module 218 then generates a ruleset and/or determines the most relevant concept from each variable for each rule. In some implementations, the rule module 218 further calculates a firing strength for each rule and/or a weight 220 for each generated rule. Put another way, the rule module 218 determines which rules of the ruleset have the greatest effect on the outcome. In some implementations, the rule module 218 determines the firing strength and/or weight 220 for each rule by a weighting system, such that each rule has potential to affect the outcome in accordance with the weight of the respective rule. In further implementations, the rule module 218 determines the firing strength and/or weight 220 for each rule by a priority system, such that the applicable rule with the greatest priority controls.

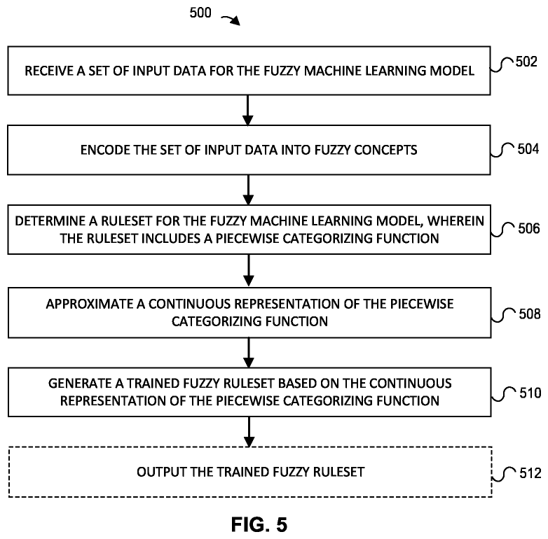

In some implementations, the rule module 218 generates a piecewise categorizing function based on the generated ruleset and/or the firing strength/weight for each rule. In particular, the piecewise categorizing function generally covers the generated ruleset and details the relationships between various input variables and the output according to the generated ruleset. After generating the piecewise categorizing function representative of the ruleset, the rule module 218 may approximate a continuous representation of the piecewise categorizing function using tropical geometry, such as a gradient descent function as described with more detail in regard to FIG. 5 below. In other implementations, the inference module 222 approximates the continuous representation rather than the rule module 218. The rule module 218 then transmits the ruleset, the piecewise categorizing function, the continuous approximation, the firing strength, and/or the weight 220 to the inference module 222. In some implementations, the inference module 222 is the inference module 140 as described with regard to FIG. 1 above.

The inference module 222 then classifies the variables based on the rule firing strength and/or weights 220 that the rule module 218 calculates. In some implementations, the inference module 222 further determines the firing strength of each class on the output using the rule firing strength and/or weights 220. In some implementations, the output 224 includes the classified variables and/or the class firing strength of the classes. In further implementations, the output 224 includes a trained model as described herein. In still further implementations, the output 224 is a basic model that a module, such as rule training module 145, trains.

The data processing server 110 may also perform a rule summary method 230. As part of the rule summary method 230, the data processing server 110 uses trained models 232, such as those described above with regard to output 224 and FIG. 1, and/or a dataset 234. In some implementations, the data processing server 110 already has access to the trained models 232 and/or dataset 234, such as from the inference module 222 or from an internal data processing database 150. In other implementations, the data processing server 110 receives the trained models 232 and/or dataset 234 from a client device 115, a rules database 120, and/or an experimental database 125. Though FIG. 2A illustrates trained models, it will be understood that the data processing server 110 may similarly perform the rule summary method 230 before or as part of training the models at the rule training module 145.

After receiving and/or retrieving the trained models 232 and/or dataset 234, the data processing server 110 performs a distance matrix calculation 236. In some implementations, the data processing server 110 performs the distance matrix calculation 236 by calculating weights for individual variables to individual rules. The data processing server 110 then averages the calculated weights over all data samples in the dataset to construct a matrix A with a size in accordance with the number of variables and the number of rules. For example, the matrix A may have size n×m, where n is the number of variables and m is the number of rules. The data processing server 110 then calculates the distance matrix based on the matrix A. In some implementations, the distance matrix is D=1−A^{T}A, where an entry d_{i,j} indicates the distance between rule i to rule j. In some implementations, the data processing server 110 performs distance matrix calculation using the piecewise categorizing function representing the generated ruleset to generate a continuous representation of the piecewise categorizing function.

After performing the distance matrix calculation 236, the data processing server 110 clusters 238 the rules into groups. In some implementations, the data processing server 110 clusters 238 the rules using a hierarchical clustering technique. In further implementations, the hierarchical clustering technique uses an agglomerative or bottom-up approach, where each rule starts with a cluster and the data processing server 110 successively merges similar clusters, minimizing the distance between pairs of clusters. In other implementations, the hierarchical clustering technique uses a divisive or top-down approach, where the rules start as a single cluster and the data processing server 110 successively divides the cluster into similar, smaller clusters.

After clustering 238 the rules, the data processing server 110 performs a representative rule selection 240. In some implementations, the data processing server 110 selects representative rules from each cluster. In further implementations, after selecting the representative rules, the data processing server 110 discards any remaining rules. In other implementations, the data processing server 110 stores the remaining rules and/or a reference to the remaining rules in the data processing database 150. Depending on the implementation, the data processing server 110 may select the representative rules from each cluster based on the firing strength and/or weight 220 of each rule. For example, the data processing server 110 may select the rule with the greatest weight 220 or contribution to the classification. In some implementations, the data processing system calculates the contribution and/or weight 220 of each rule as the average of the weights for a rule over data samples in the dataset. In further implementations, the data processing server 110 performs or confirms representative rule selection 240 by iteratively determining a local minimum and/or maximum of the ruleset using a gradient descent algorithm and modifying the overall ruleset based on such. For example, depending on the implementation, the data processing server 110 can remove any rules resulting in local minima or maxima and/or keeping only rules that result in local minima or maxima to construct a continuous approximation of the piecewise categorizing function representative of the ruleset. The data processing server 110 then outputs the set of summarized rules 242 as summarized by the rule summary method 230.

Referring next to FIG. 2B, a diagram illustrates further systems and methods for receiving an input dataset and extracting rules therefrom. The system 200B may implement methods as described with regard to FIG. 5 below. Though the system below is described with reference to system 100, it will be recognized that any similarly suitable system may be used to implement FIG. 2B.

The diagram illustrates a system 200B including multiple modules and layers for analysis. In particular, the system 200B includes an input layer 250, encoding module 260, rule module 270, and inference module 280. In some implementations, the inference module 280 also serves as an output layer and may be referred to as such herein. In further implementations, the system 200B is part of system 100 and may be the data processing server 110. Similarly, each of the encoding module 260, rule module 270, and inference module 280 may include or be each of the encoding module 130, rules module 135, and inference module 140, respectively.

At the input layer 250, the system 200B receives input datasets. In some implementations, the input datasets include any of ordinal variables, continuous variables, categorical variables, rules, trained rules, and/or any combination thereof. In further implementations, the input layer identifies and separates ordinal and continuous variables 252 xᵢ from categorical variables 254 xⱼ. Though FIG. 2B illustrates two variables, it will be understood that this is for ease of illustration and understanding, and the system may receive any number of input variables divided in any proportion between ordinal and continuous variables 252, categorical variables 254, and/or other forms of input data.

The encoding module 260 receives the input data from the input layer 250 and encodes the input data into one or more fuzzy concepts. In some implementations, the encoding module 260 encodes the input data differently based on the variable type. For example, the encoding module 260 may encode ordinal and/or continuous variables 252 based on a predetermined number of fuzzy concepts as described with regard to FIG. 1. Similarly, the encoding module 260 may encode categorical variables 254 with regard to the number of layers Lⱼ each variable has, as described with regard to FIG. 1.

In the exemplary embodiment of FIG. 2B, the encoding module 260 encodes ordinal and/or continuous variables 252 into three fuzzy concepts, a low concept 262, a medium concept 264, and a high concept 266. In some implementations, the fuzzy concepts are the low concept 262

$$l ( {x}_{i} ) = {f}_{{ϵ}_{1}} ( \frac{{a}_{i , 2} - x}{{a}_{i , 2} - {a}_{i , 1}} ) - {f}_{{ϵ}_{1}} ( \frac{{a}_{i , 1} - x}{{a}_{i , 2} - {a}_{i , 1}} ) ,$$

the medium concept 264

$$m ( {x}_{i} ) = {f}_{{ϵ}_{1}} ( \frac{x - {a}_{i , 1}}{{a}_{i , 2} - {a}_{i , 1}} ) - {f}_{{ϵ}_{1}} ( \frac{x - {a}_{i , 2}}{{a}_{i , 2} - {a}_{i , 1}} ) - {f}_{{ϵ}_{1}} ( \frac{{a}_{i , 3} - x}{{a}_{i , 4} - {a}_{i , 3}} ) + {f}_{{ϵ}_{1}} ( \frac{{a}_{i , 4} - x}{{a}_{i , 4} - {a}_{i , 3}} ) - 1 ,$$

and the high concept 266

$$h ( {x}_{i} ) = {f}_{{ϵ}_{1}} ( \frac{x - {a}_{i , 3}}{{a}_{i , 4} - {a}_{i , 3}} ) - {f}_{{ϵ}_{1}} ( \frac{x - {a}_{i , 4}}{{a}_{i , 4} - {a}_{i , 3}} ) , \\ where {f}_{{ϵ}_{1}} ( x ) = {ϵ}_{1} log ( 1 + exp ( \frac{x}{{ϵ}_{1}} ) ) ,$$

tunable hyperparameters α_{i,1}<α_{i,2}<α_{i,3}<α_{i,4}, and 0<∈₁<1 as defined above. In further implementations, the encoding module 260 encodes the categorical variables 254 into encoded concepts 268A-268L, defined as l₁(xⱼ), . . . , l_{Lj}(xⱼ), where only one of l₁(xⱼ), . . . , l_{Lj}(xⱼ) has a value of 1, while all others have a value of 0.

The rule module 270 determines a firing strength of each variable on each rule as well as the firing strength of each rule. In particular, the rule module determines a vector \tilde{x}ᵢ 272 comprising entries 272A-272K \tilde{x}_{i,1} to \tilde{x}_{i,K} for variable 252 xᵢ, as well as the corresponding vector 276 \tilde{x}ⱼ and entries 276A-276K \tilde{x}_{j,1} to \tilde{x}_{j,K} for variable 254 xⱼ. In some implementations, the rule module 270 determines the vectors and entries based on a determined attention matrix A and the corresponding entries for each concept and each entry of the vectors \tilde{x}ᵢ and \tilde{x}ⱼ. For example, the low concept 262 may represent the contribution of the variable xᵢ 252 on a first rule entry vector by the attention matrix entry A_{i,l,1} and on a Kth rule entry by the attention matrix entry A_{i,l,K}. Similarly, the encoded concept 268A may represent the contribution of the ordinal variable xⱼ 254 on a first rule entry by the attention matrix entry A_{j,1,1} and on a Kth rule entry by the attention matrix entry A_{j,1,K}. In some implementations, the rule module 270 uses the attention matrix entries to generate a piecewise categorizing function representative of the ruleset. For example, the rule module 270 may use the entries to determine for what fuzzy concepts a variable xᵢ contributes positively to the output and generate the piecewise categorizing function based on such.

The rule module 270 further determines the firing strength r₁, . . . , r_{K} 274A-274K based on a connection matrix M as described in more detail with regard to FIG. 1 above. An entry M_{i,k} in the connection matrix denotes the contribution of the variable to the kth rule, constructed from the rule entry vectors \tilde{x}_{1,k}, . . . , \tilde{x}_{H,k}. In particular, the firing strength of a rule K, r_{K} 274K, depends on the corresponding entry for each connection matrix, constructed for each variable. Put another way, M_{i,K}, M_{j,K}, and every other such matrix determines the firing strength r_{K} 274K as described with regard to FIG. 1 above.

The inference module 280 determines a firing strength for each class into which the system 200B classifies the variables. In particular, the inference module determines class firing strengths o₁, . . . , o_{c} 282A-282C. In some implementations, the inference module 280 determines the class firing strengths 282A-282C based on an inference matrix W. In some such implementations, each rule firing strength 274A-274K affects each class firing strength 282A-282C. For example, the rule firing strength r₁ 274A has a contribution on each class firing strength 282A-282C in accordance with the matrix entries W_{1,1}, . . . , W_{1,c}.

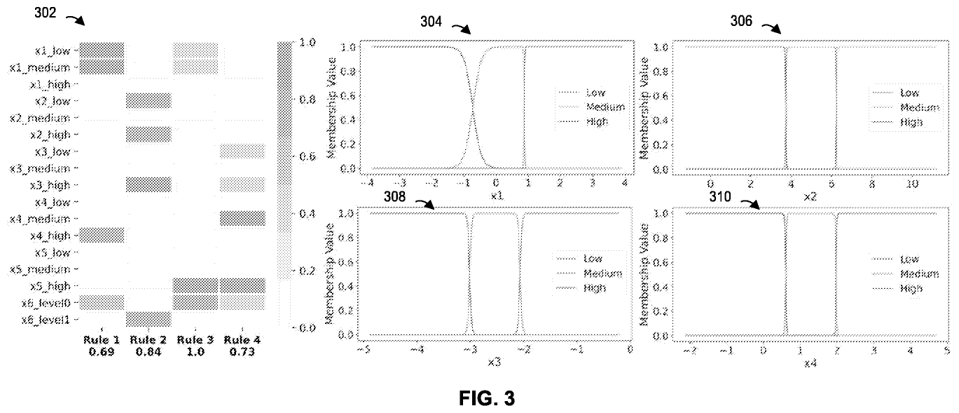

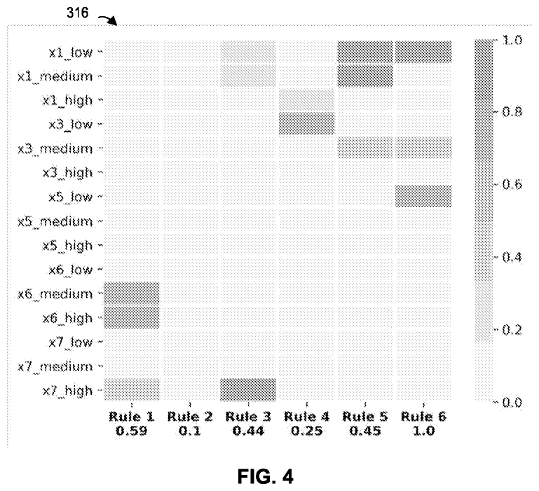

Referring next to FIGS. 3-4, example graphs 302, 312, 314, 316, and 318 illustrate example visualizations of rulesets and concepts, as well as contributions of the rulesets to positive classes. Further example graphs 304, 306, 308, and 310 indicate the determined membership functions for concepts of various input variables.

In an example implementation, the system 100 may be set up and implemented as follows. A 10-fold cross-validation may be used to evaluate model performance. For each iteration, the dataset can be split into training, validation, and test sets. A random search algorithm can be applied using the training set and validation set for hyperparameter tuning, including learning rate, batch size, λ₁, λ₂, and ∈ₘᵢₙ.

Compared to popular “black box” machine learning algorithms—such as random forest, SVM, and XGBoost—and other interpretable models—such as logistic regression, decision tree, and Explainable Boosting Machine (EBM)—evaluated using a 10-fold cross-validation, the techniques as described herein provide better accuracy, recall, precision, F1, and area under the ROC curve (AUC) than almost all such models while still providing transparency. Moreover, the techniques as described herein has significantly lower generalization error than such black box methods.

In an example implementation, the system 100 receives eight input variables: x₁˜N(0,2), x₂˜N(5,3), x₃˜N(−1,5), x₄˜N(1,2), x₅˜N(−2,1), x₆˜Bernoulli(0,5), x₇˜N(0,1), and x₈˜N(0,1). Further, the following rules are true for the dataset. Should any of the rules apply to an observation, then the observation is positive and otherwise is negative: Rule A: x₂<3.8 and x₃>−2 and x₆=1; Rule B: x₂>6.3 and x₃>−2 and x₆=1; Rule C: x₁<1 and x₄>2 and x₆=0; Rule D: x₃>0 and x₅>−1 and x₆=0; and Rule E: x₁>1 and x₅>−1.5 and x₆=0. In some further example implementations, random noise sampled from N(0,0.01) is added to the input variables. Further, the system 100 determines that the observations do not rely on x₇ and x₈, so the system 100 deems the variables in question irrelevant.

In the above example, the system 100 receives 400 samples from the dataset, the percentage of positive samples is 34.25%, and the percentages of samples with Rule A, Rule B, Rule C, Rule D, and Rule E are 8.25%, 7.50%, 9.00%, 10.75%, and 2.00%, respectively. The system 100 generates a visual rule summary 302 of a summarized ruleset generated using the input dataset. As the visual rule summary 302 illustrates, Rule 1 corresponds with Rule C, Rule 2 corresponds with a union of Rule A and Rule B, Rule 3 corresponds with Rule D, and Rule 4 is similar to Rule E. As such, the system 100 generates a majority of the rules accurately and generates the final rule similarly due to only 2.00% of samples being consistent with Rule E.

Similarly, in the above example, the system generates visualizations of membership functions 304, 306, 308, and 310 for variables involved in Rule 1 and Rule 2. Notably, each graph accurately portrays the relationships between the relevant input variables (304 depicts x₁, 306 depicts x₂, 308 depicts x₃, and 310 depicts x₄). For example, graph 306 illustrates that the membership value of x₂ for the “low” concept is high when x₂ is smaller than 3.7 and the membership value of x₂ for the “high” concept is high when x₂ is larger than 6.2, which is nearly identical to the rules in question.

In another example implementation, the system 100 receives nine input variables x₁˜N(0,2), x₂˜N(5,3), x₃˜N(˜1,5), x₄˜N(1,2), x₅˜N(−2,1), x₆˜N(−1,4.4), x₇˜N(0,1.2), x₈˜N(0,1), and x₉˜N(0,1), and the sample is positive when

$$\frac{{( {x}_{1} + 0.5 {x}_{2} + {x}_{3} )}^{2}}{1 + {e}^{{x}_{6}} + 2 {x}_{7}} < 1.$$

In the example implementation, the system 100 receives 400 samples from the dataset. The generated ruleset visualization 316 demonstrates that Rule 1 shows that “high” levels of x₆ and x₇ lead to a positive class, since 1+e^{x6}+2x₇ becomes larger, and thus more likely to cause the expression to be less than 1. Similarly, Rules 4 and 5 illustrate that a low x₃ and a high x₁ or a low/medium x₁ and medium x₃ can similarly lead to a positive class, as (x₁+0.5x₂+x₃)² becomes smaller.

Referring next to FIG. 5, a flowchart illustrates a method 500 for receiving an input dataset and extracting rules therefrom. The method of FIG. 5 may be implemented in a system 100 as described with regard to FIG. 1 above. Though the method below is described with regard to system 100, it will be recognized that any similarly suitable system may be used to implement method 500.

At block 502, the data processing server 110 receives a set of input data for the fuzzy machine learning model. In some implementations, the input data includes ordinal variables, continuous variables, categorical variables, rules, trained rulesets, and/or any combination thereof. In particular, the input data represents data that a practitioner or expert may use to come to a conclusion, i.e., an element of a rule or a rule in totality. For example, in some implementations, the data processing server 110 improves and/or generates rules about determining the heart health of a patient. The input data, then, may represent information such as blood pressure, heartbeat, rate of heart murmurs, etc. In other implementations, the data processing server 110 improves and/or generates rules about determining the viability of stock market decisions, and the input data represents information such as stock performance, user liquid assets, potential effect on the wider market, etc. In yet other implementations, the data processing server 110 improves and/or generates rules about determining network security. As such, the input data represents information related to security, such as frequency of alarms, frequency of expected entries, likelihood of attempted intrusion, etc. In still yet other implementations, the data processing server 110 improves and/or generates rules about making any similar such determination, and the input data reflects the determination accordingly.

At block 504, the data processing server 110 encodes the set of input data into fuzzy concepts. In some implementations, an encoding module 130 encodes the set of input data. Depending on the implementation, the data processing server 110 and/or encoding module 130 may encode the input data differently depending on the type. For example, the data processing server 110 and/or the encoding module 130 may treat ordinal and continuous variables differently from categorical variables. In further implementations, the data processing server 110 and/or encoding module 130 encodes the input data into fuzzy concepts based on concepts common to each variable. For example, the data processing server 110 and/or encoding module 130 may determine that the input variables may have fuzzy concepts of “high”, “medium”, and “low”, such as blood pressure, frequency of alarms, and/or stock performance. In other implementations, the data processing server 110 and/or encoding module 130 determines fuzzy concepts for each variable individually.

At block 506, the data processing server 110 determines a ruleset for the fuzzy machine learning model, wherein the ruleset includes a piecewise categorizing function. In some implementations, the data processing server 110 receives at least part of the ruleset as input data at block 502. In further implementations, the data processing server 110 determines at least part of the ruleset based on variables received as input data at block 502 and encoded at block 504. In some such implementations, the data processing server 110 determines the rules by the rules module 135 and/or the inference module 140 as described above with regard to FIG. 1.

In further implementations, at least part of the ruleset is determined according to tropical geometry. Put another way, in such implementations at least part of the ruleset is a piecewise function. In some such implementations, the piecewise function represents a disparate space and is further representative of relationships between the variables and outcomes. In further implementations, the data processing server 110 determines the piecewise categorizing function according to the encoded fuzzy concepts using determined firing strengths for rules and/or attention matrix entries as described with regard to FIGS. 1-2B above.

At block 508, the data processing server 110 approximates a continuous representation of the piecewise categorizing function. Normally, piecewise functions cannot be analyzed using gradient-based operations, as piecewise functions may not be differentiable. However, by providing a close approximation of the piecewise function, the data processing server 110 may use such gradient-based operations to analyze the function, providing a faster and more accurate determination. As such, the data processing server 110 determines a smooth, continuous function representative of the piecewise function. In some implementations, the data processing server 110 determines the continuous representation of the piecewise function such that the continuous representation is infinitely close to the piecewise version. Depending on the implementation, data processing server 110 may use the rule module 130, the inference module 140, or the model training module 145 to determine the continuous representation and/or approximation of the piecewise function. For example, in some implementations, the data processing server 110 creates the continuous representation by calculating a continuous function that is infinitely close to the piecewise approximation at the rule module 130. In further implementations, the data processing server 110 uses the class firing strengths determined at the inference module 140 to determine an appropriate continuous approximation. In still further implementations, the data processing server 110 receives the piecewise categorizing function representative of the generated ruleset at the model training module 145 and generates the continuous approximation before or while training the model, as described above with regard to FIG. 2A.

At block 510, the data processing server 110 generates a trained fuzzy ruleset based on the continuous representation of the piecewise categorizing function. In some implementations, the data processing server 110 generates the trained fuzzy ruleset by determining a distance matrix based on at least the continuous representation of the piecewise categorizing function. In some such implementations, the distance matrix is representative of similarity between one or more rules of the ruleset. The data processing server 110 then determines clusters of rules based on the distance matrix. Depending on the implementation, the data processing server 110 may determine the clusters using a bottom-up hierarchical clustering technique, as described in more detail with regard to FIG. 2A above. In such implementations, the data processing system then generates the trained fuzzy ruleset by determining representative rules from each cluster. Depending on the implementation, then data processing server 110 may determine the representative rules based on contribution to an output classification, as described in more detail with regard to FIG. 2A above.

In implementations in which the input data includes at least one rule, the data processing server 110 may generate the trained fuzzy ruleset by determining that the rules can be improved and training the rules as described herein. In some implementations, the data processing server 110 determines that the rules can be improved based on the piecewise categorizing function of the rules as determined in block 506.

In some implementations, the data processing server 110 further generates the trained fuzzy ruleset by using gradient-based techniques to determine local maxima and/or minima in the continuous representation of the piecewise categorizing function. Subsequently, the data processing server 110 generates the trained fuzzy ruleset based on the local minima and/or the local maxima of the ruleset. Depending on the implementation, the data processing server 110 then iteratively trains one or more parameters of the ruleset to improve the fuzzy ruleset. In further implementations, the data processing server 110 improves a model representative of the ruleset and/or created by the ruleset rather than directly improving the ruleset.

At block 512, the data processing server 110 outputs the trained fuzzy ruleset. In some implementations, the data processing server 110 classifies the input variables and outputs the variables in accordance with the classifications. The data processing server 110 outputs the ruleset and/or the classifications of the variables according to the fuzzy nature of the rulesets. Put another way, the data processing server 110 outputs the ruleset and/or the classifications such that a human is able to understand and use the ruleset. For example, the output ruleset may indicate that if a first variable is high and a second variable is low, then the outcome is positive. Similarly, the output may further indicate classifications and/or concepts related to the input variables. For example, the output may indicate that a first variable is “high” and influences the determination of the outcome in a positive manner, in accordance with the above rule. In some implementations, the data processing server 110 further outputs a model created by the trained fuzzy ruleset. In further implementations, the data processing server 110 further outputs information related to training the fuzzy ruleset. For example, the data processing server 110 may output an indication of the contribution of each rule to the one or more outcome classes. In some other implementations, the data processing server 110 does not explicitly output any results to the user, and instead the output is the model as a whole. As such, in such implementations, the data processing system may skip block 512.

Depending on the implementation, the input data may have an explicit temporal component (e.g., the data is time series data). As such, the trained model makes decisions at multiple time points. For example, in a financial-focused example, the trained model may need to evaluate the performance of a particular stock multiple times each day due to the rapid changes of the stock market. In a network security implementation, the trained model may similarly make such decisions multiple times to ensure a consistently secure network. In some such implementations, the data processing server 110 updates the model and/or ruleset at each time point. In other implementations, the data processing server 110 instead initially trains the model and/or ruleset and only updates the training occasionally or at predetermined time intervals.

In an implementation, data processing server 110 may train a ruleset and/or model with regard to medical purposes. For example, the data processing server 110 may train a ruleset and/or model to determine when a patient is afflicted with heart failure (HF). In such an implementation, the input variable(s) may be or include any of the following variables: age, sex, heart rate, systolic blood pressure, sodium concentration, albumin concentration, uric acid concentration, total cholesterol concentration, hemoglobin concentration, lymphocyte percentage, 6-minute walk total distance, gate speed, 15-feet walk time, left ventricular dimension (diastole), left ventricular ejection fraction (biplane), eight-item patient health questionnaire depression scale score, mitral regurgitation, glomerular filtration rate, pulse pressure, comorbidity index (without depression), peak oxygen consumption during a maximum cardiopulmonary exercise test, prior treatment with cardiac resynchronization therapy, presence of a temporary MCS device, prior treatment with guideline-directed medical therapy for HF, working or doing household chores, hobbies, recreational activities, visiting family or friends outside of home, number of times fatigue has limited ability to partake in activities, number of times a patient has been forced to sleep sitting up because of shortness of breath, etc. Depending on the implementation, the input data may be in the form of binary options, integers, limited integers, floating point decimals, general numerical values, strings, or any other similar format. The trailed ruleset and/or model may then train or create rules and/or analyze the input data to make determinations with regard to the health of a patient.

In another implementation, the data processing server 110 may train a ruleset and/or model with regard to financial purposes. For example, the data processing server 110 may train a ruleset and/or model to determine whether to sell or buy stocks for a stock portfolio. In such an implementation, the input variable(s) may be or include any of the following variables: existing stock performance over a predetermined time period, 401(k), age, average retirement age, industry, salary, insurance, employment benefits, stock market forecasts, recent world events, recently released products, ad campaigns, endorsements, other portfolio decisions, survey data related to user, survey data related to companies, user risk threshold, budgeting decisions, tax returns, user company preferences, company type, business model, etc. Depending on the implementation, the input data may be in the form of binary options, integers, limited integers, floating point decimals, general numerical values, strings, or any other similar format. The trailed ruleset and/or model may then train or create rules and/or analyze the input data to make determinations with regard to financial decisions.

As yet another example, the data processing server 110 may train a ruleset and/or model with regard to network security. For example, the data processing server 110 may train a ruleset and/or model to determine whether an unauthorized user has infiltrated a network. In such an implementation, the input variable(s) may be or include any of the following variables: IP address of any users, authorization codes and/or signals of any users, results of zero-knowledge proof authentication, encryption formats, encryption keys, public and/or private keys, network purpose, security measures and/or ratings of security measures, number of past incidents, number of past false alarms, average time spent on network by users, maximum time spent on network by users, minimum time spent on network by users, time caps for users, average data transfer via network by users, past maximum data transfer via network by users, past minimum data transfer via network by users, data transfer caps for users, tiers of network access, etc. Depending on the implementation, the input data may be in the form of binary options, integers, limited integers, floating point decimals, general numerical values, strings, or any other similar format. The trailed ruleset and/or model may then train or create rules and/or analyze the input data to make determinations with regard to security decisions.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Moreover, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A method for generating and training a fuzzy machine learning model, the method comprising:
receiving, by one or more processors, a set of input data for the fuzzy machine learning model;
encoding, by the one or more processors, the set of input data into fuzzy concepts, wherein the fuzzy concepts are representative of approximate logical relationships between variables;
determining, by one or more processors and based on the fuzzy concepts, a ruleset for the fuzzy machine learning model, wherein rules of the ruleset are based on a piecewise categorizing function; and
training, by the one or more processors, the ruleset for the fuzzy machine learning model based on the set of input data by:
approximating, using tropical geometry, a continuous representation of the piecewise categorizing function, and
generating, based on at least the continuous representation of the piecewise categorizing function, a trained fuzzy ruleset.

2. The method of claim 1, wherein generating the trained fuzzy ruleset includes:
determining, based on at least the continuous representation of the piecewise categorizing function, a distance matrix, wherein the distance matrix is representative of similarity between one or more rules of the ruleset,
determining, based on the distance matrix, clusters of rules for the one or more rules of the ruleset, and
generating the trained fuzzy ruleset by determining representative rules from each cluster of the clusters of rules.

3. The method of claim 1, wherein the set of input data for the fuzzy machine learning model includes at least one rule, and wherein the ruleset for the fuzzy machine learning model includes the at least one rule.

4. The method of claim 3, wherein generating the trained fuzzy ruleset includes:
determining, based on at least the continuous representation of the piecewise categorizing function, the at least one rule can be improved; and
training the at least one rule.

5. The method of claim 4, wherein training the ruleset is agnostic to an accuracy of the at least one rule.

6. The method of claim 1, further comprising:
determining, responsive to training the ruleset, a firing strength for each parameter of at least one rule of the trained fuzzy ruleset; and
determining, responsive to training the ruleset, a firing strength for each rule of the trained fuzzy ruleset.

7. The method of claim 6, further comprising:
determining, responsive to determining the firing strength of each parameter and the firing strength of each rule, the contribution of each rule to one or more outcome classes.

8. The method of claim 1, wherein generating the trained fuzzy ruleset includes:
iteratively training one or more parameters of the ruleset to find a local minimum output and/or a local maximum output of the ruleset using a gradient descent algorithm; and
generating the trained fuzzy ruleset based on the local minimum output and/or the local maximum output of the ruleset.

9. The method of claim 1, wherein the piecewise categorizing function defines whether a received variable follows a high membership function, a medium membership function, or a low membership function.

10. The method of claim 1, wherein the fuzzy machine learning model is configured to receive input data as each of ordinal variable data, continuous variable data, or categorical variable data.

11. A system for generating and training a fuzzy machine learning model, the system comprising:
one or more processors;
a memory; and
a non-transitory computer-readable medium coupled to the one or more processors and the memory and storing instructions thereon that, when executed by the one or more processors, cause the computing device to:
receive a set of input data for the fuzzy machine learning model;
encode the set of input data into fuzzy concepts, wherein the fuzzy concepts are representative of approximate logical relationships between variables;
determine, based on the fuzzy concepts, a ruleset for the fuzzy machine learning model, wherein rules of the ruleset are based on a piecewise categorizing function; and
train the ruleset for the fuzzy machine learning model based on the set of input data by:
approximating, using tropical geometry, a continuous representation of the piecewise categorizing function, and
generating, based on at least the continuous representation of the piecewise categorizing function, a trained fuzzy ruleset.

12. The system of claim 11, wherein generating the trained fuzzy ruleset includes:
determining, based on at least the continuous representation of the piecewise categorizing function, a distance matrix, wherein the distance matrix is representative of similarity between one or more rules of the ruleset,
determining, based on the distance matrix, clusters of rules for the one or more rules of the ruleset, and
generating the trained fuzzy ruleset by determining representative rules from each cluster of the clusters of rules.

13. The system of claim 11, wherein the set of input data for the fuzzy machine learning model includes at least one rule, and wherein the ruleset for the fuzzy machine learning model includes the at least one rule.

14. The system of claim 13, wherein generating the trained fuzzy ruleset includes:
determining, based on at least the continuous representation of the piecewise categorizing function, the at least one rule can be improved; and
training the at least one rule.

15. The system of claim 14, wherein training the ruleset is agnostic to an accuracy of the at least one rule.

16. The system of claim 11, wherein the non-transitory computer-readable medium further stores instructions that, when executed by the one or more processors, cause the computing device to further:
determine, responsive to training the ruleset, a firing strength for each parameter of at least one rule of the trained fuzzy ruleset; and
determine, responsive to training the ruleset, a firing strength for each rule of the trained fuzzy ruleset.

17. The system of claim 16, wherein the non-transitory computer-readable medium further stores instructions that, when executed by the one or more processors, cause the computing device to further:
determine, responsive to determining the firing strength of each parameter and the firing strength of each rule, the contribution of each rule to one or more outcome classes.

18. The system of claim 11, wherein generating the trained fuzzy ruleset includes:
iteratively training one or more parameters of the ruleset to find a local minimum output and/or a local maximum output of the ruleset using a gradient descent algorithm; and
generating the trained fuzzy ruleset based on the local minimum output and/or the local maximum output of the ruleset.

19. The system of claim 11, wherein the piecewise categorizing function defines whether a received variable follows a high membership function, a medium membership function, or a low membership function.

20. The system of claim 11, wherein the fuzzy machine learning model is configured to receive input data as each of ordinal variable data, continuous variable data, or categorical variable data.
